(19) United States
(12) Patent Application Publication
(10) Pub. No.: US 2021/0021917 A1
(43) Pub. Date: Jan. 21, 2021

(54) OUTDOOR BLUETOOTH SPEAKER WITH ADJUSTABLE CLIP FASTENER AND LANYARD HOLDER

(71) Applicant: Thane Holland, Colorado Springs, CO (US)

(72) Inventor: Thane Holland, Colorado Springs, CO (US)

(21) Appl. No.: 17/063,482

(22) Filed: Oct. 5, 2020

Related U.S. Application Data
(60) Provisional application No. 62/714,946, filed on Aug. 6, 2018.
(60) Provisional application No. 62/882,620, filed on Aug. 5, 2019.

(51) Int. Cl. H04R 1/02; F16B 2/24

(52) U.S. Cl. CPC H04R 1/02; F16B 2/24

(57) ABSTRACT

A portable speaker may include a clip and lanyard fastener permanently affixed to the speaker. The fastener can either be molded to the body of the speaker or affixed by other methods. The clip function can open to a predetermined angle while retaining pressure onto whatever object it is meant to hold. A slideable screw assembly including a screw with a pointed end in a sliding bracket may be provided to further secure any item to be affixed. The portable speaker may also include an integrated lanyard hole or bracket to enable connection of a lanyard.

### CROSS-REFERENCE TO RELATED APPLICATIONS

This non-provisional utility application claims priority to provisional application No. 62/882,620 filed Aug. 5, 2019 and entitled, “OUTDOOR BLUETOOTH SPEAKER WITH ADJUSTABLE CLIP FASTENER AND LANYARD HOLDER” and provisional application No. 62/714,946 filed Aug. 6, 2019, the contents of which is incorporated entirely herein.

### TECHNICAL FIELD

The present disclosure relates to the field of portable speaker holders.

### BACKGROUND

In today's world people carry their music anywhere they go. Usually they carry their music in their mobile phones. When they are going camping or to a party, they might carry a portable speaker, e.g, a “Bluetooth” speaker, which uses a a wireless communication protocol such as IEEE 802.15 (“Bluetooth”) to wirelessly connect the speaker to a media source, such as a mobile phone, tablet, or portable computer.

Playing music in a mobile phone has its own limitations. The volume of a mobile phone may be low, and ambient noise in outdoor environments may make it almost inaudible for all practical purposes.

A Bluetooth speaker on the other hand may produce a greater volume in a wider area. Bluetooth speakers may also provide greater battery life due to the larger size of the speaker, enabling it to accommodate a larger battery, and more limited use to drain the batter, as unlike a mobile phone, the speaker may not have to expend power on powering the modem, running applications, opened or in the background, or supporting an operating system.

However, Bluetooth speakers may be more difficult to carry in hand, especially if one is involved in physical activities such as trekking, camping or fishing. This deprives music lovers of their favorite music when outdoors and on the move.

Therefore there is a need for a Bluetooth speaker that is easy to carry and/or attach to one's body or apparel even during outdoor physical activities.

### DESCRIPTION OF THE DRAWINGS

FIG. 1 is a side view of a portable speaker with a clip assembly in a “closed” position in accordance with an embodiment.

FIG. 2 is a side view of the portable speaker of FIG. 1 with the clip assembly in an “open” position.

FIG. 3 is a plan view of a clip assembly according to a embodiment.

FIG. 4 is a side view of the clip assembly shown in FIG. 3.

FIG. 5 is a cross-sectional view of the clip assembly shown in FIG. 3.

FIG. 6 is perspective view of a sliding bracket according to an embodiment.

FIG. 7 is a perspective view of a thumb screw according to an embodiment.

FIG. 8 is a perspective view of a square nut according to an embodiment.

It should be noted that accompanying figures are not necessarily drawn to scale and are intended to represent exemplary embodiments.

### DETAILED DESCRIPTION

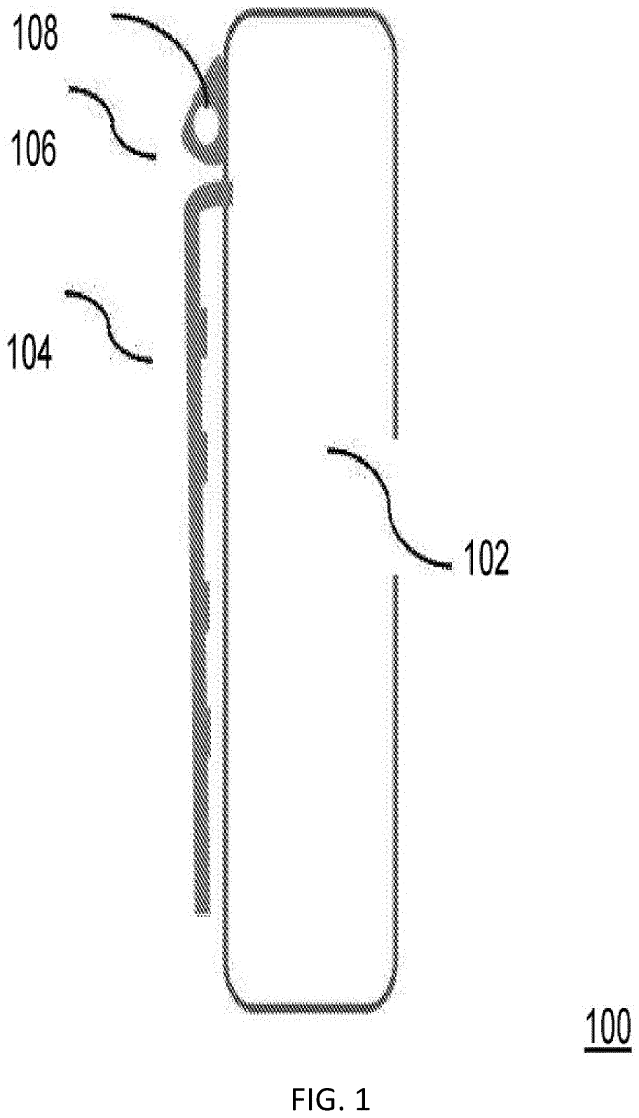

FIG. 1 shows a side view of a portable speaker attachment system 100 including a portable speaker 102 including a clip 104.

In FIG. 1, the clip is shown in a “closed” position. The clip 104 may allow the portable speaker 102 to attach to variety of articles, including, e.g., belts, bag straps, rope, etc. This may make it easier for a user to carry the portable speaker 102 even while being involved in physical outdoor activities such as trekking and camping. The portable speaker 102 may be water- and/or dust-resistant, e.g., IP67 or IP68 compliant, and be available in a variety of high visibility colors.

An exemplary portable speaker 102 may have dimensions on the order of 4 inch×2 inch×1 inch, making it portable and easy to carry, although other dimensions are within the scope of the disclosure.

The portable speaker 102 may further include a holder 106 and a lanyard hole 108. The lanyard hole 108 enables connection of a lanyard, that is, a cord or a string that can be worn on a user's body, such as around the neck, or used to hang the speaker from inanimate objects, such as branches, beams, ropes, etc.

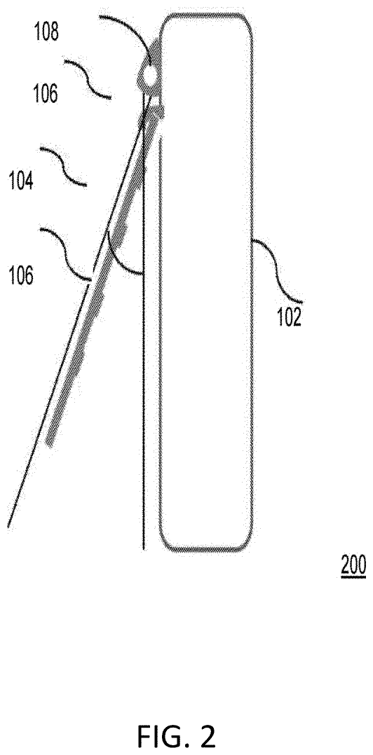

FIG. 2 shows a side view of the portable speaker 102 with the clip 104 in an “open” position. The clip 104 may open to a predefined angle 106. In an embodiment, the predefined angle 106 is up to 70 degrees. This makes it possible to secure the portable speaker 102 to a variety of articles such as belts, bags, fishing waders, rope, tree branches, or clothes of various thicknesses.

In another embodiment, the portable speaker 102 may include a semi-flexible clip including a slideable attachment system.

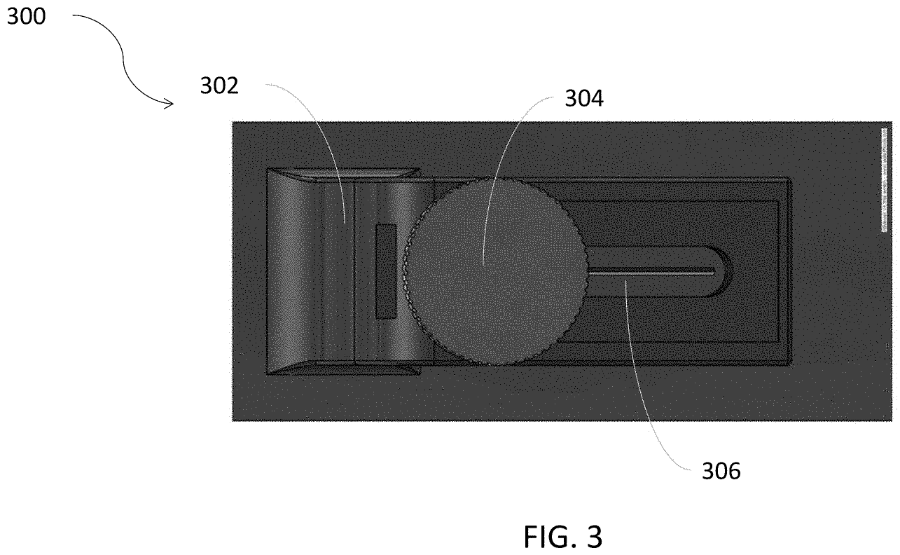

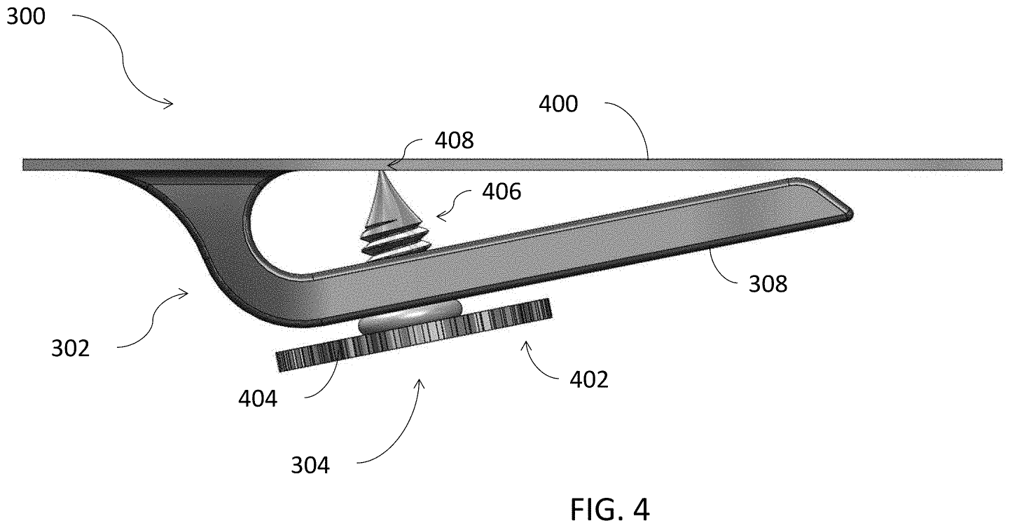

FIG. 3 shows a clip assembly 300 including a hinge 302, thumb screw 304, and sliding bracket 306. The hinge 302 may be a jointed mechanism, spring loaded mechanism, or a curved portion of metal with sufficient flexibility to allow a clip arm 308 (shown in FIG. 4) to accept an attachment object (not shown), such as a belt, rope, metal strap, edge of a structure, etc.

FIG. 4 is a side view of the clip assembly 300. The clip assembly 300 includes a base 400 that may be affixed to the portable speaker 102 or part of the portable speaker housing. In this embodiment, the hinge 302 is a semi-flexible, curved portion at an end of the clip arm 308. The thumb screw 304 may include a circular, plate head 402 that may be turned to move the screw body and pointed end inward to engage with the material of the attachment object. The screw head may include ridges 404 on its outer edge to enable a better grip for the user's fingers. The body 406 of the thumb screw 304 extends through the clip arm 308 and sliding bracket 306, and include a pointed tip 408.

In operation, the clip assembly 300 may accept the attachment object, and depending on the thickness of the attachment object, the thumb screw 304 may be slid to a desired position, e.g., one the user decides would provide the most secure attachment, and the thumb screw engaged, i.e., screwed into the material of the attachment object, such that the thumb screw tip 408 provides sufficient pressure to provide a secure attachment between the portable speaker 102 and the attachment object.

The degree of engagement may be “finger tight”, i.e., using only the user's index finger and thumb to secure the thumb screw. Another tool may also be used, such as a wrench or pliers, to provide an even tighter engagement, based on the user's discretion regarding the perceived level of activity and risk of disengagement and subsequent loss of the portable speaker 102.

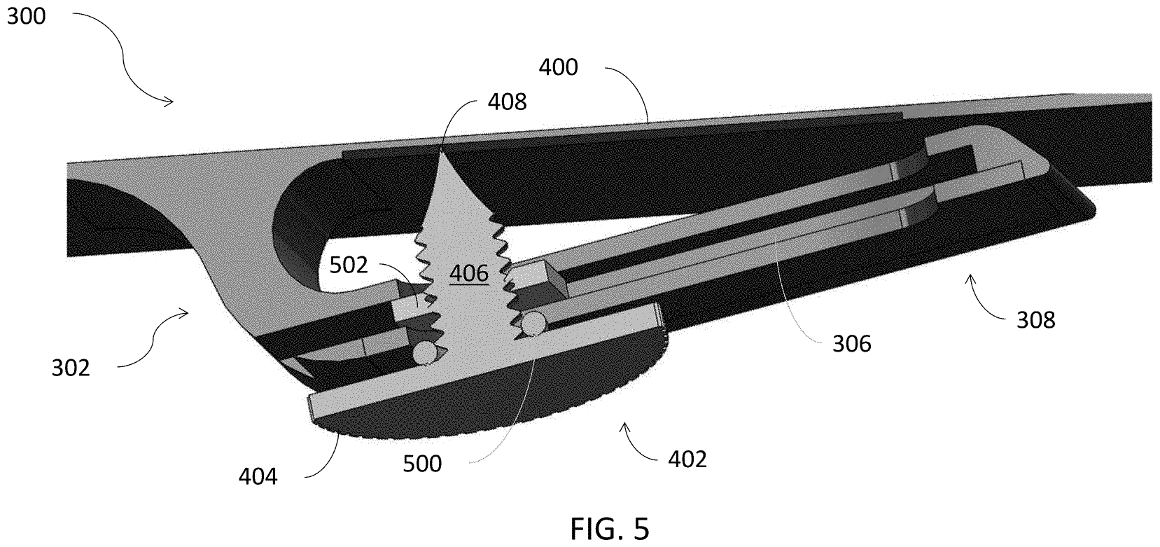

FIG. 5 is a cross-sectional view of the clip assembly 300. The thumb screw 304 may be attached through the clip arm 308 and sliding bracket 306 with a washer 500 and a square nut 502

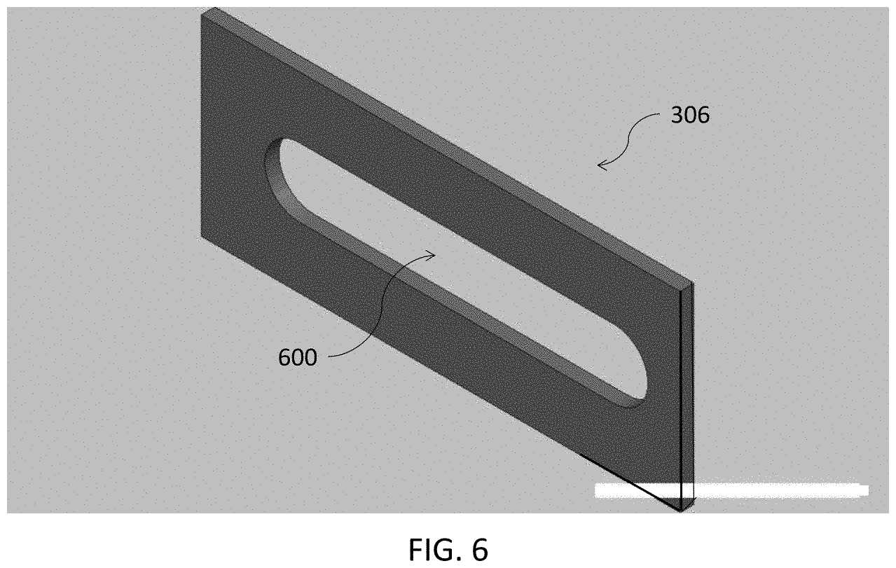

FIG. 6 is perspective view of the sliding bracket 306. The sliding bracket may include a linear aperture 600 to accept the body 406 of the thumb screw 304.

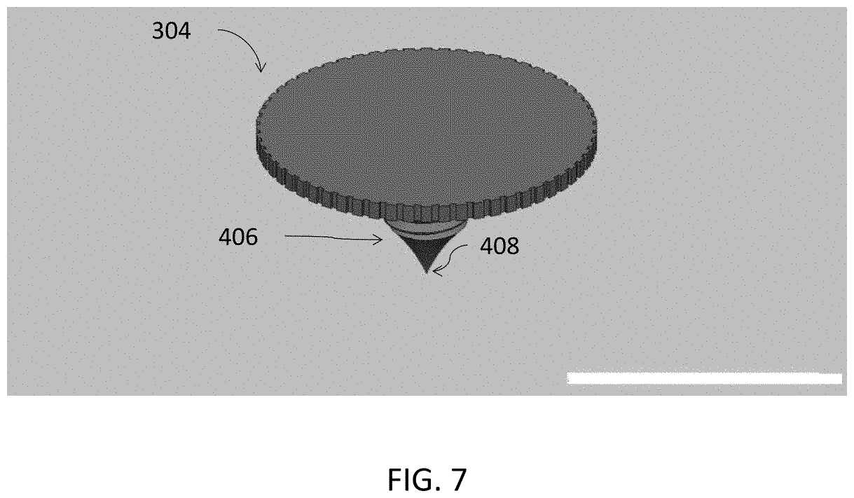

FIG. 7 is a perspective view of the thumb screw 304 according to an embodiment.

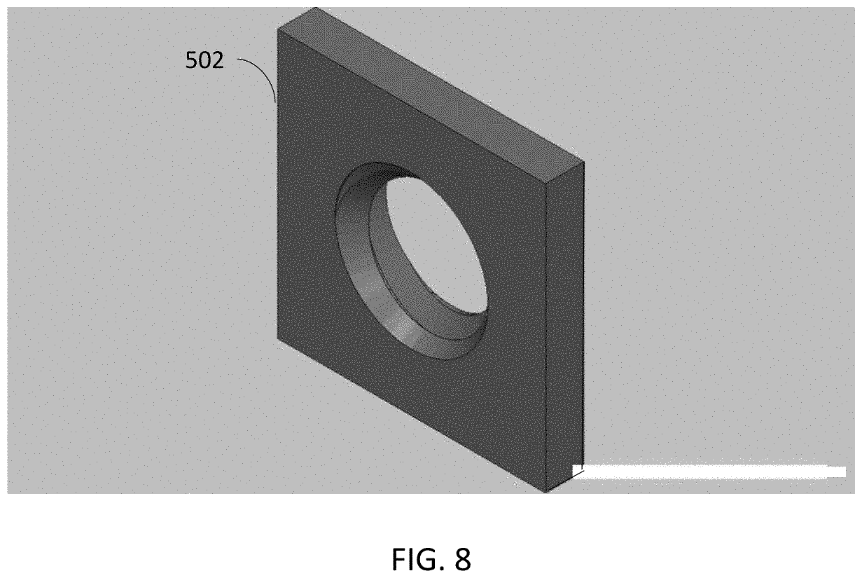

FIG. 8 is a perspective view of the square nut 502 according to an embodiment.

While the present invention has been related in terms of the foregoing embodiments, those skilled in the art will recognize that the invention is not limited to the embodiments depicted. The present invention may be practiced with modification and alteration within the spirit and scope of the appended claims. Thus, the description is to be regarded as illustrative instead of restrictive on the present invention.

1. A portable speaker assembly comprising:
a speaker including a housing; and
a clip assembly comprising:
a base attached to the housing,
a clip arm attached to the base, the clip arm including a bracket with an aperture,
a hinge connected between the base and the clip arm, and
slideable securing means configured to be moved along the aperture and secure and object inserted between the clip arm and the base.

2. The portable speaker assembly of claim 1, wherein the slideable securing means comprises a screw movable connected to the bracket through the aperture by a coupling device.

3. The portable speaker assembly of claim 2, wherein the coupling device comprises a washer on a first side of the bracket and a nut on the other side of the bracket.

4. The portable speaker assembly of claim 1, further comprising one of a hole in the housing or bracket attached to the housing configured to accept a lanyard.
